(19) United States
(12) Patent Application Publication
(10) Pub. No.: US 2019/0244287 A1
(43) Pub. Date: Aug. 8, 2019

(54) UTILIZING A MACHINE LEARNING MODEL AND BLOCKCHAIN TECHNOLOGY TO MANAGE COLLATERAL

(71) Applicant: Accenture Global Solutions Limited, Dublin (IE)

(72) Inventors: Debi Prasad Datta, Chennai (IN); Harish Murali Sankaranarayanan, Chennai (IN); K. Satishkumar, Chennai (IN)

(21) Appl. No.: 16/265,554

(22) Filed: Feb. 1, 2019

(30) Foreign Application Priority Data
Feb. 5, 2018 (IN) 201841004279

(51) Int. Cl. G06Q 40/02; G06N 20/00

(52) U.S. Cl. CPC G06Q 40/025; G06N 20/00

(57) ABSTRACT

A device receives, via a blockchain, eligibility schedule data that includes collateral inventory and eligibility criteria associated with a collateral giver and a collateral receiver on a date, and receives, via a smart contract, transaction details data that includes transaction details associated with the collateral giver and the collateral receiver on the date. The device processes the eligibility schedule data and the transaction details data, with a trained machine learning model, to determine a first collateral allocation between the collateral giver and the collateral receiver on the date, and processes the eligibility schedule data and the transaction details data, with a linear programming model, to determine a second collateral allocation between the collateral giver and the collateral receiver on the date. The device determines whether the first collateral allocation is predicted to result in a collateral allocation failure, and selectively implements the first collateral allocation or the second collateral allocation.

### RELATED APPLICATION

This application claims priority under 35 U.S.C. § 119 to Indian Patent Application No. 201841004279, filed on Feb. 5, 2018, the content of which is incorporated by reference herein in its entirety.

### BACKGROUND

Collateral is used to provide security against the risk of default by an opposing party in a transaction or trade. Financial institutions (e.g., banks) deal with transactions, such as repossessions, security lending and borrowing, over-the-counter (OTC) derivatives, loans, and/or the like, and collateralize the transactions to control exposure. The financial institutions maintain an inventory of collateral, and collateralize transactions based on agreements between transacting parties and collateral allocation strategies adopted by the financial institutions. Many financial institutions handle collateral allocation based on an order and prioritize strategy that typically results in uncovered exposures (e.g., transactions not being covered by collateral) and approximately twenty-five percent of the inventory of collateral being unutilized.

### SUMMARY

According to some implementations, a method may include receiving a request for a collateral allocation between a collateral giver and a collateral receiver on a date, and receiving eligibility schedule data via a blockchain and based on the request, wherein the eligibility schedule data may include collateral inventory and eligibility criteria associated with the collateral giver and the collateral receiver on the date. The method may include receiving transaction details data via a smart contract and based on the request, wherein the transaction details data may include transaction details associated with the collateral giver and the collateral receiver on the date, and processing the eligibility schedule data and the transaction details data, with a machine learning model, to determine a first collateral allocation between the collateral giver and the collateral receiver on the date. The method may include processing the eligibility schedule data and the transaction details data, with a linear programming model, to determine a second collateral allocation between the collateral giver and the collateral receiver on the date, and determining whether the first collateral allocation is predicted to result in a collateral allocation failure. The method may include selectively implementing the first collateral allocation or the second collateral allocation, wherein the first collateral allocation may be implemented when the first collateral allocation is predicted to not result in the collateral allocation failure, and wherein the second collateral allocation may be selectively implemented when the first collateral allocation is predicted to result in the collateral allocation failure.

According to some implementations, a device may include one or more memories, and one or more processors, communicatively coupled to the one or more memories, to receive a request for a collateral allocation between a collateral giver and a collateral receiver on a date, and receive eligibility schedule data via a blockchain and based on the request, wherein the eligibility schedule data may include collateral inventory and eligibility criteria associated with the collateral giver and the collateral receiver on the date. The one or more processors may receive transaction details data via a smart contract and based on the request, wherein the transaction details data may include transaction details associated with the collateral giver and the collateral receiver on the date, and may process the eligibility schedule data and the transaction details data, with a first model, to determine a first collateral allocation between the collateral giver and the collateral receiver on the date. The one or more processors may process the eligibility schedule data and the transaction details data, with a second model, to determine a second collateral allocation between the collateral giver and the collateral receiver on the date, wherein the second model may be a different type of model than the first model. The one or more processors may determine whether the first collateral allocation is predicted to result in a collateral allocation failure, and may perform one or more actions based on the first collateral allocation or the second collateral allocation and based on whether the first collateral allocation is predicted to result in the collateral allocation failure.

According to some implementations, a non-transitory computer-readable medium may store instructions that include one or more instructions that, when executed by one or more processors of a device, cause the one or more processors to receive eligibility schedule data via a blockchain, wherein the eligibility schedule data may include collateral inventory and eligibility criteria associated with a collateral giver and a collateral receiver on a date. The one or more instructions may cause the one or more processors to receive transaction details data via a smart contract, wherein the transaction details data may include transaction details associated with the collateral giver and the collateral receiver on the date, and process the eligibility schedule data and the transaction details data, with a trained machine learning model, to determine a first collateral allocation between the collateral giver and the collateral receiver on the date, wherein a machine learning model may be trained with historical exposure allocation data to generate the trained machine learning model that determines a collateral allocation based on inputted eligibility schedule data and inputted transaction details data. The one or more instructions may cause the one or more processors to process the eligibility schedule data and the transaction details data, with a linear programming model, to determine a second collateral allocation between the collateral giver and the collateral receiver on the date, and determine whether the first collateral allocation is predicted to result in a collateral allocation failure. The one or more instructions may cause the one or more processors to selectively implement the first collateral allocation or the second collateral allocation, wherein the first collateral allocation may be implemented when the first collateral allocation is predicted to not result in the collateral allocation failure, and wherein the second collateral allocation may be selectively implemented when the first collateral allocation is predicted to result in the collateral allocation failure.

### BRIEF DESCRIPTION OF THE DRAWINGS

FIGS. 1A-1H are diagrams of an example implementation described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for utilizing a machine learning model and blockchain technology to manage collateral.

### DETAILED DESCRIPTION

The following detailed description of example implementations refers to the accompanying drawings. The same reference numbers in different drawings may identify the same or similar elements.

Linear programming model-based collateral allocation is based on current transaction information available on a particular day, which may cause transactions on a following day to fail. For example, for a transaction of $10,000, the linear programming model may utilize various collateral constraints (e.g., eligibility of collateral; haircut information, such as a difference between a market value of an asset used as loan collateral and an amount of the loan; and/or the like) to optimize the collateral allocation from a collateral pool such that the $10,000 is collateralized with government securities or cash or a combination of both (e.g., depending on the collateral allocation strategy of the financial institution) if the counter party accepts such collateral. In this example, the collateral allocation strategy for that day might allocate $10,000 worth of government securities and exhaust the inventory of government securities. However, if there were to be another transaction the next day, with another a party who is only willing to accept government securities as a covered collateral, the transaction would fail.

When transactions fail due to collateral allocations, computing resources (e.g., processing resources, memory resources, and/or the like), networking resources, and/or the like, associated with collateral allocations, are wasted identifying the failed transactions, correcting the failed transactions, determining successful collateral allocations, and/or the like.

Some implementations described herein provide a collateral platform that utilizes a machine learning model and blockchain technology to manage collateral. For example, the collateral platform may receive a request for a collateral allocation between a collateral giver and a collateral receiver on a date, and may receive eligibility schedule data via a blockchain and based on the request. The eligibility schedule data may include collateral inventory and eligibility criteria associated with the collateral giver and the collateral receiver on the date. The collateral platform may receive transaction details data via a smart contract and based on the request, wherein the transaction details data may include transaction details associated with the collateral giver and the collateral receiver on the date. The collateral platform may process the eligibility schedule data and the transaction details data, with a machine learning model, to determine a first collateral allocation between the collateral giver and the collateral receiver on the date. The collateral platform may process the eligibility schedule data and the transaction details data (e.g., with a linear programming model) to determine a second collateral allocation between the collateral giver and the collateral receiver on the date, and may determine whether the first collateral allocation is predicted to result in a collateral allocation failure. The collateral platform may selectively implement the first collateral allocation or the second collateral allocation. The first collateral allocation may be implemented when the first collateral allocation is predicted to not result in the collateral allocation failure, and the second collateral allocation may be selectively implemented when the first collateral allocation is predicted to result in the collateral allocation failure.

In this way, the collateral platform utilizes a machine learning model and blockchain technology to manage collateral allocations and ensure that transactions do not fail due to the collateral allocations. This conserves computing resources, networking resources, and/or the like that would otherwise be wasted identifying failed transactions, correcting failed transactions, determining successful collateral allocations, and/or the like.

In some implementations, the collateral platform may predict future transactions, and may provide a futuristic view of transaction values between different parties in order to optimize allocations across different collateral classes on that day so that future transaction failures are reduced.

In some implementations, the collateral platform may handle thousands, millions, billions, and/or the like, of collateral allocations within a period of time (e.g., daily, weekly, monthly), and thus may provide “big data” capability. The big data handled by the collateral platform may be so voluminous and complex that traditional data processing applications cannot be used.

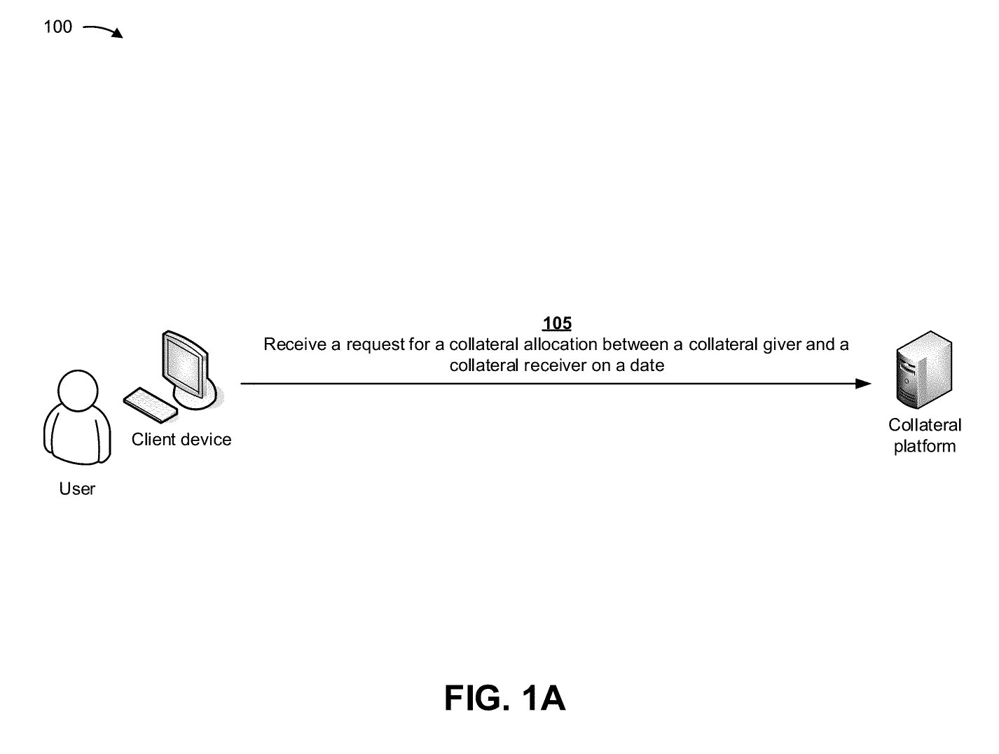

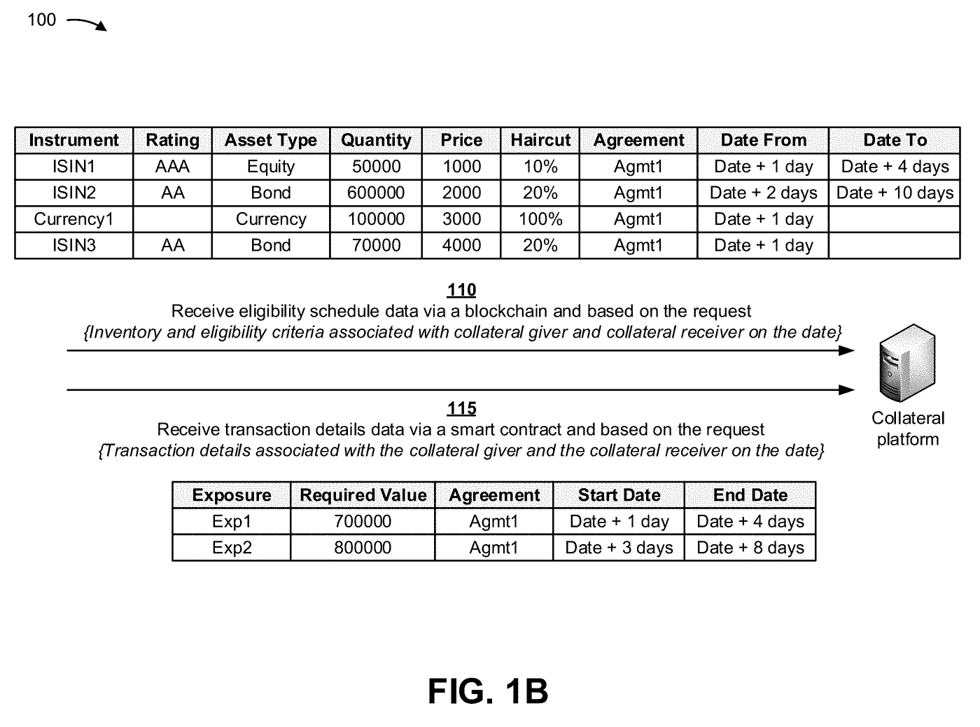

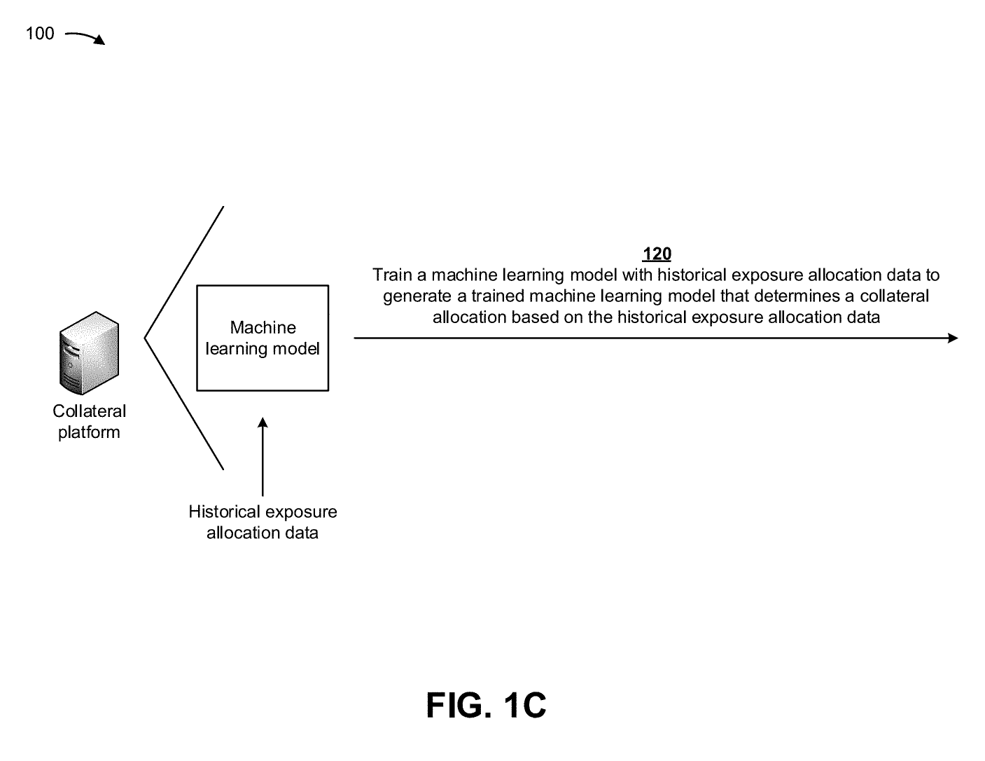

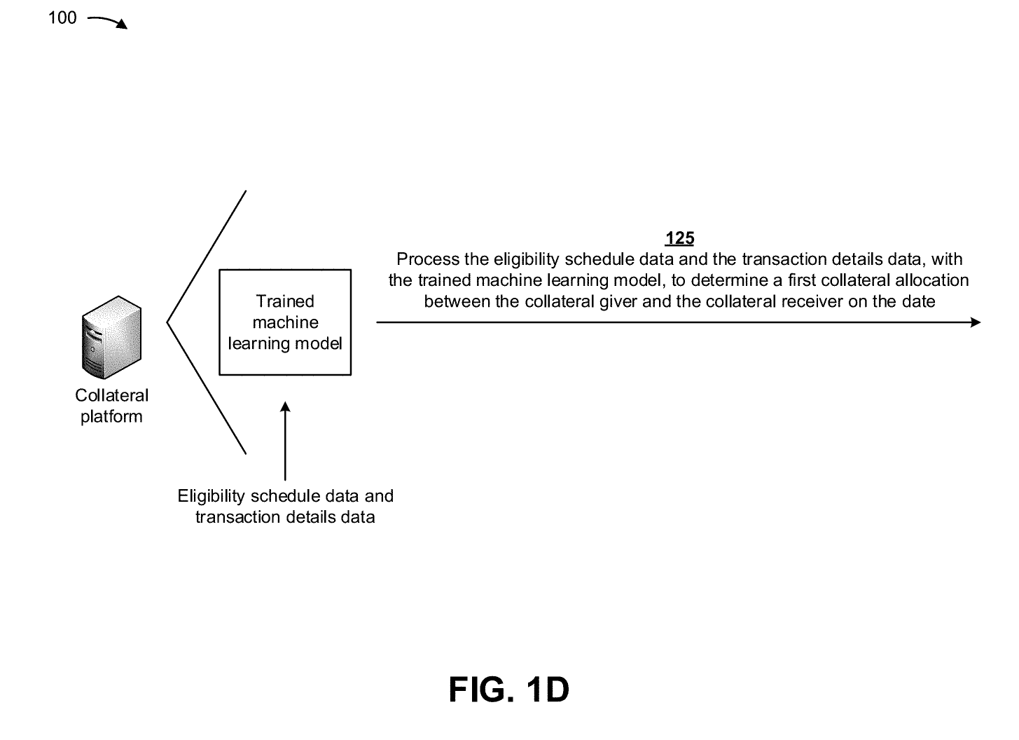

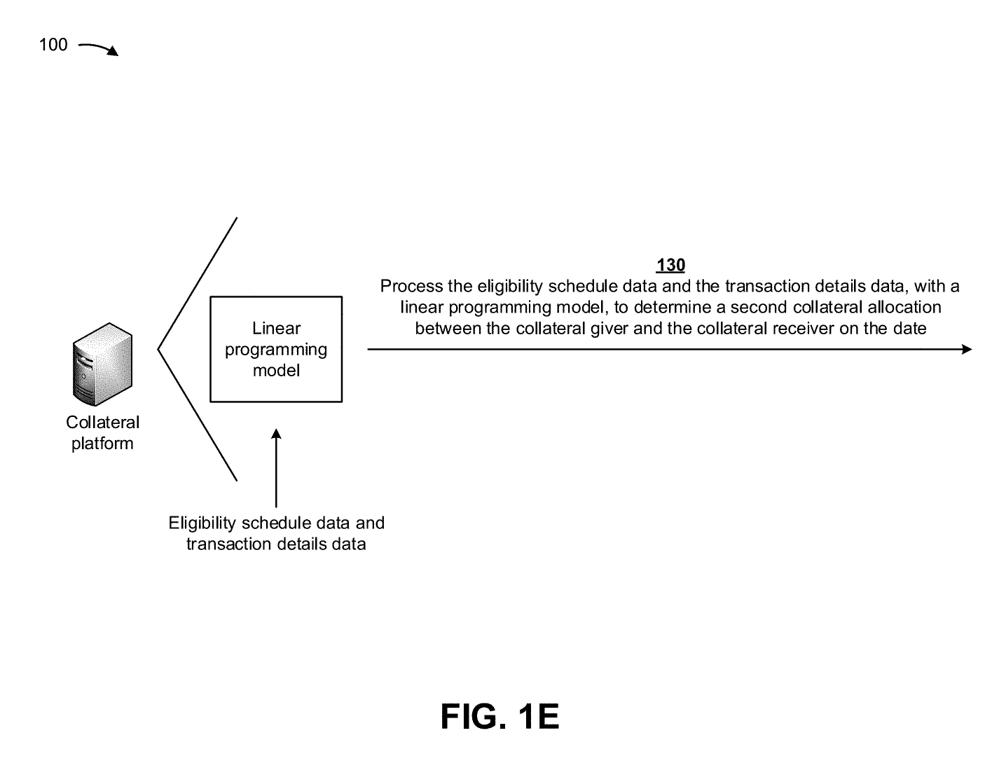

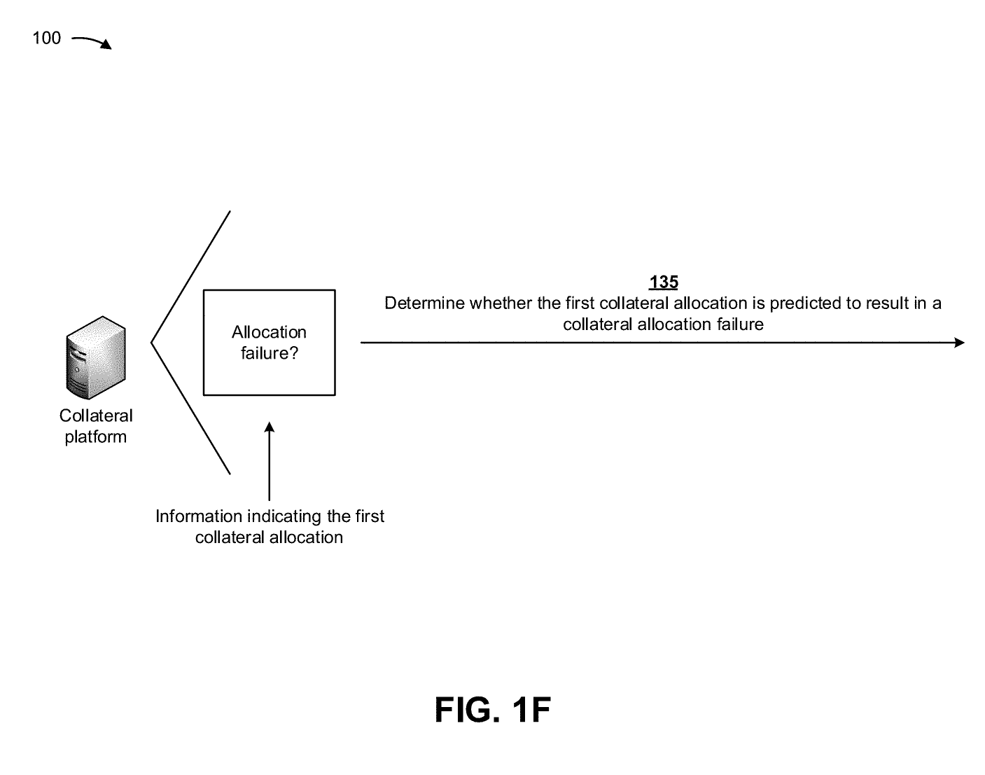

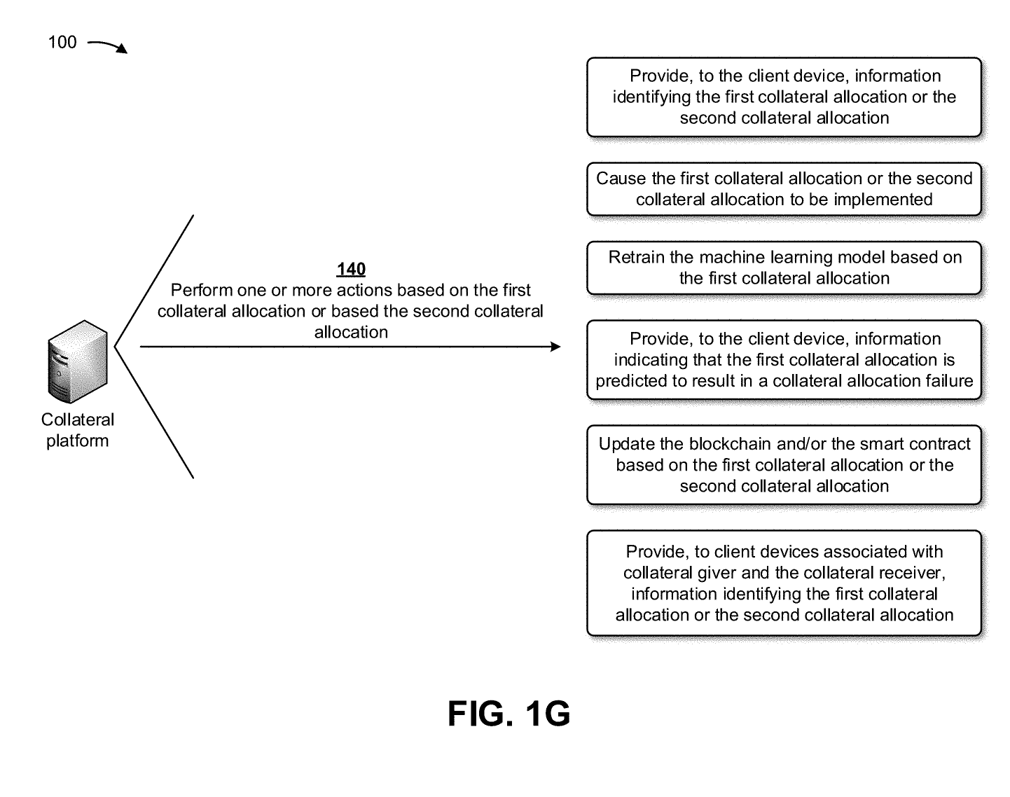

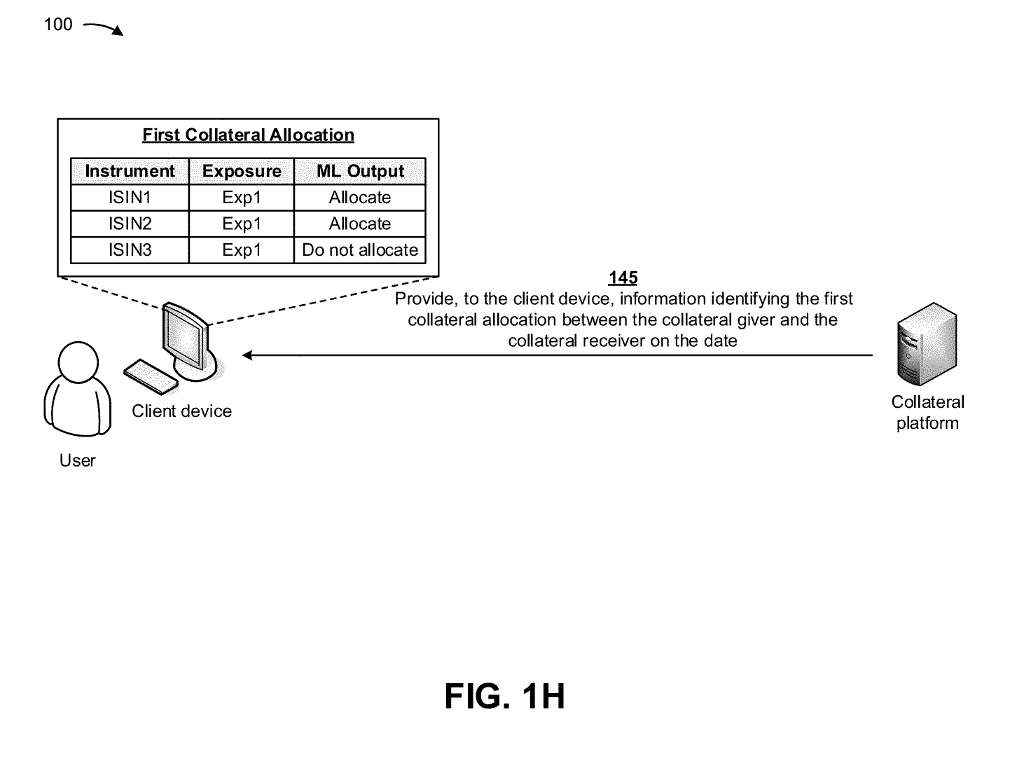

FIGS. 1A-1H are diagrams of an example implementation 100 described herein. As shown in FIG. 1A, a user may be associated with a client device and a collateral platform. The user may wish to determine a collateral allocation between a collateral giver and a collateral receiver on a date (e.g., a date of the collateral allocation), and may cause the client device to provide a request for a collateral allocation to the collateral platform. As further shown in FIG. 1A, and by reference number 105, the collateral platform may receive, from the client device, the request for the collateral allocation between the collateral giver and the collateral receiver on the date. In some implementations, the user may not need to generate a request, but may view collateral allocations (e.g., via the client device) associated with the user, by accessing the collateral platform (e.g., via an account of the user with the collateral platform).

In some implementations, the collateral may include money, company stocks, government securities (e.g., Treasury bonds, Treasury bills, municipal bonds, and/or the like), real estate, personal property, cryptocurrencies, digital assets, intellectual property, and/or the like. In some implementations, the user may be associated with the collateral giver, and the collateral giver may include a financial institution. In some implementations, the collateral receiver may include a counter or opposing party that is conducting a transaction with the financial institution.

As shown in FIG. 1B, and by reference number 110, the collateral platform may receive eligibility schedule data via a blockchain and based on the request. In some implementations, the collateral platform may receive the eligibility schedule data from the client device, from a data structure (e.g., a database, a table, a list, and/or the like) associated with the collateral platform, from a server device associated with the collateral platform, and/or the like. In some implementations, the eligibility schedule data may include data indicating inventory and eligibility criteria associated with the collateral giver and the collateral receiver on the date. For example, as shown in FIG. 1B, the eligibility schedule data may include data identifying collateral instruments (e.g., international securities identification numbers (ISINs) that identify securities, currencies, real estate, personal property, cryptocurrencies, digital assets, and/or the like); data identifying ratings for the collateral instruments (e.g., A, AA, AAA, and/or the like); data identifying types associated with the collateral instruments (e.g., equities, bonds, currencies, and/or the like); data identifying quantities of the collateral instruments (e.g., 50000, 600000, etc.); data identifying prices associated with the collateral instruments (e.g., $1000, $2000, etc.); data identifying haircuts associated with the collateral instruments (e.g., differences between market values of the collateral instruments and amounts of loans, such as 10%, 20%, etc.); data identifying agreements associated with the collateral instruments; data identifying dates from which the collateral instruments are available; data identifying dates to which the collateral instruments are available; and/or the like.

In some implementations, the blockchain providing the eligibility schedule data may include a continuously growing list of records, called blocks, which are linked and secured using cryptography. Each block contains a hash pointer as a link to a previous block, a timestamp, and transaction data (e.g., each block may include many transactions). By design, a blockchain is inherently resistant to modification of the transaction data. A blockchain may be managed by a peer-to-peer network of nodes (e.g., devices) collectively adhering to a consensus protocol for validating new blocks. Once recorded, the transaction data in a given block cannot be altered retroactively without the alteration of all previous blocks, which requires collusion of a majority of the network nodes. A blockchain is an append-only data structure maintained by a network of nodes that do not fully trust each other. All nodes in a blockchain network agree on an ordered set of blocks, and each block may contain multiple transactions. Thus, a blockchain may be viewed as a log of ordered transactions.

In some implementations, collateral prices may be managed and/or maintained over the blockchain and collateral events may be generated over the blockchain. In this way, the blockchain reduces disputes about collateral allocations and reduces re-allocations of collateral.

As further shown in FIG. 1B, and by reference number 115, the collateral platform may receive transaction details data via a smart contract and based on the request. In some implementations, the collateral platform may receive the transaction details data from the client device, from a data structure (e.g., a database, a table, a list, and/or the like) associated with the collateral platform, from a server device associated with the collateral platform, and/or the like. In some implementations, the transaction details data may include data indicating transaction details associated with the collateral giver and the collateral receiver on the date. For example, the transaction details data may include data identifying exposures (e.g., possibilities of transactions not being covered by collateral) associated with the transactions; data identifying required values for the collateral covering the transactions (e.g., 700000, 800000, etc.); data identifying agreements associated with the transactions (e.g., as provided via the smart contract); data identifying start dates from which the collateral is to cover the transactions; data identifying end dates to which the collateral is to cover the transactions; and/or the like.

In some implementations, the smart contract may include a particular type of blockchain (e.g., an Ethereum blockchain, an R3 Corda blockchain, and/or the like) that allows a user to define complex computations. A smart contract is a computer protocol that facilitates, verifies, and/or enforces negotiation or performance of a contract. Once deployed, a smart contract is executed, e.g., on all Ethereum nodes as a replicated state machine. The Ethereum node includes an execution engine (e.g., an Ethereum virtual machine (EVM)) that executes a smart contract.

In some implementations, the collateral platform may implement agreements and collateral inventory (e.g., associated the collateral allocation) over a blockchain and/or a smart contract. In such implementations, the blockchain technology (e.g., the blockchain, smart contracts, and/or the like) eliminates a need for generation of settlement instructions for the collateral allocation since a settlement may occur over the blockchain for any changes of exposures, prices of collateral, agreement terms, and/or the like.

As further shown in FIG. 1C, and by reference number 120, the collateral platform may train a machine learning model with historical exposure allocation data to generate a trained machine learning model that determines a collateral allocation based on the historical exposure allocation data. In some implementations, the machine learning model may include a prediction model that ensures allocation of particular collateral to particular exposures, considers future probabilities associated with collateral, provides a more optimized collateral allocation, and/or the like. In some implementations, the machine learning model may include a local regression (e.g., LOESS) model, a random sample consensus (RANSAC) model, and/or the like.

The LOESS model is a non-parametric regression model that combines multiple regression models in a k-nearest-neighbor-based meta-model. The LOESS model is a locally weighted polynomial regression. At each point in a range of a data set, a low-degree polynomial is fitted to a subset of the data, with explanatory variable values near a point whose response is being estimated. The polynomial is fitted using weighted least squares, giving more weight to points near the point whose response is being estimated and less weight to points further away. The value of the regression function for the point is then obtained by evaluating the local polynomial using the explanatory variable values for that data point. A LOESS fit is complete after regression function values have been computed for each of the data points. Many of the details of the LOESS model, such as the degree of the polynomial model and the weights, are flexible.

Subsets of data used for each weighted least-squares fit in the LOESS model are determined by a nearest neighbor algorithm. A specified input to the LOESS model, called the bandwidth or smoothing parameter, determines how much of the data is used to fit each local polynomial. The smoothing parameter (α) is a fraction of a total number (n) of data points that are used in each local fit. The subset of data used in each weighted least-squares fit thus comprises the (nα) points (rounded to a next largest integer) whose explanatory variables values are closest to the point at which the response is being estimated. Since a polynomial of degree (k) requires at least (k+1) points for a fit, the smoothing parameter (α) is between (λ+1)/n and 1, where (λ) is a degree of the local polynomial.

The local polynomials fit to each subset of the data are of first or second degree (e.g., either locally linear or locally quadratic). Using a zero-degree polynomial turns the LOESS model into a weighted moving average. The LOESS model is based on the assumptions that any function can be approximated in a small neighborhood by a low-order polynomial and that simple models can be fit to data.

A weight function gives the most weight to the data points nearest the point of estimation and the least weight to the data points that are furthest away. The use of the weights is based on the assumption that points near each other in the explanatory variable space are more likely to be related to each other in a simple way than points that are further apart. Following this logic, points that are likely to follow the local model influence the local model parameter estimates the most. Points that are less likely to actually conform to the local model have less influence on the local model parameter estimates. In some implementations, the weight function used for the LOESS model may include a tri-cube weight function, but other weight functions may be utilized.

The RANSAC model is an iterative model that estimates parameters of a mathematical model from a set of observed data that contains outliers, when outliers are to be accorded no influence on the values of the estimates. Therefore, the RANSAC model can be interpreted as an outlier detection model. The RANSAC model is a non-deterministic model that produces a reasonable result only with a certain probability, with this probability increasing as more iterations are permitted.

In some implementations, the collateral platform may utilize one or more other machine learning models, such as one or more prediction models; one or more models that ensure allocation of particular collateral to particular exposures, consider future probabilities associated with collateral, and provide a more optimized collateral allocation; and/or the like.

In some implementations, the historical exposure allocation data may include historical eligibility schedule data (e.g., historical data indicating inventory and eligibility criteria associated with collateral givers and collateral receivers, such as data identifying collateral instruments, data identifying ratings for the collateral instruments, data identifying types associated with the collateral instruments, data identifying quantities of the collateral instruments, data identifying prices associated with the collateral instruments, etc.); historical transactions data (e.g., historical data indicating transaction details associated with collateral givers and collateral receivers, such as data identifying exposures associated with transactions, data identifying required values for collateral covering the transactions, data identifying agreements associated with the transactions, etc.); and/or the like.

In some implementations, the collateral platform may perform a training operation on the machine learning model with the historical exposure allocation data. For example, the collateral platform may separate the historical exposure allocation data into a training set, a validation set, a test set, and/or the like. The training set may be utilized to the train the machine learning model. The validation set may be utilized to validate is predicted to result of the trained machine learning model. The test set may be utilized to test operation of the machine learning model. In some implementations, the collateral platform may train the machine learning model using, for example, an unsupervised training procedure and based on the training set of the historical exposure allocation data. For example, the collateral platform may perform dimensionality reduction to reduce the historical exposure allocation data to a minimum feature set, thereby reducing resources (e.g., processing resources, memory resources, and/or the like) to train the machine learning model, and may apply a classification technique to the minimum feature set.

In some implementations, the collateral platform may use a logistic regression classification technique to determine a categorical outcome (e.g., information indicating a collateral allocation for a transaction). Additionally, or alternatively, the collateral platform may use a naïve Bayesian classifier technique. In this case, the collateral platform may perform binary recursive partitioning to split the historical exposure allocation data into partitions and/or branches and use the partitions and/or branches to perform predictions (e.g., information indicating a collateral allocation for a transaction). Based on using recursive partitioning, the collateral platform may reduce utilization of computing resources relative to linear sorting and analysis of data points, thereby enabling use of thousands, millions, or billions of data points to train the machine learning model, which may result in a more accurate model than using fewer data points.

Additionally, or alternatively, the collateral platform may use a support vector machine (SVM) classifier technique to generate a non-linear boundary between data points in the training set. In this case, the non-linear boundary is used to classify test data into a particular class.

Additionally, or alternatively, the collateral platform may train the machine learning model using a supervised training procedure that includes receiving input to the machine learning model from a subject matter expert, which may reduce an amount of time, an amount of processing resources, and/or the like to train the machine learning model of activity automatability, relative to an unsupervised training procedure. In some implementations, the collateral platform may use one or more other model training techniques, such as a neural network technique, a latent semantic indexing technique, and/or the like. For example, the collateral platform may perform an artificial neural network processing technique (e.g., using a two-layer feedforward neural network architecture, a three-layer feedforward neural network architecture, and/or the like) to perform pattern recognition with regard to particular insights indicated in the historical exposure allocation data. In this case, using the artificial neural network processing technique may improve an accuracy of the trained machine learning model generated by the collateral platform by being more robust to noisy, imprecise, or incomplete data, and by enabling the collateral platform to detect patterns and/or trends undetectable to systems using fewer and/or less complex techniques.

In some implementations, the collateral platform may receive the trained machine learning model from another source and may retrain the machine learning model as described below.

As shown in FIG. 1D, and by reference number 125, the collateral platform may process the eligibility schedule data and the transaction details data, with the trained machine learning model, to determine a first collateral allocation between the collateral giver and the collateral receiver on the date. In some implementations, the machine learning model may utilize the eligibility schedule data and the transaction details data to determine an allocation of collateral from the collateral giver to the collateral receiver on the date. In some implementations, the first collateral allocation may include data identifying collateral instruments to allocate (e.g., provided in the eligibility schedule data) from the collateral giver to the collateral receiver on the date, data identifying collateral instruments (e.g., provided in the eligibility schedule data) not to allocate from the collateral giver to the collateral receiver on the date, data identifying exposures associated with the collateral instruments, and/or the like.

As shown in FIG. 1E, and by reference number 130, the collateral platform may process the eligibility schedule data and the transaction details data, with a linear programming model, to determine a second collateral allocation between the collateral giver and the collateral receiver on the date. In some implementations, the linear programming model may include a model that determines a best outcome (e.g., an optimized collateral allocation) based on requirements represented by linear relationships. The linear programming model may include a type of mathematical programming known as mathematical optimization. In some implementations, the linear programming model may determine the collateral allocation based on current transaction information available on a date. In some implementations, the linear programming model may utilize the eligibility schedule data and the transaction details data to determine an allocation of collateral from the collateral giver to the collateral receiver on the date. In some implementations, the second collateral allocation may include data identifying collateral instruments to allocate (e.g., provided in the eligibility schedule data) from the collateral giver to the collateral receiver on the date, data identifying collateral instruments (e.g., provided in the eligibility schedule data) not to allocate from the collateral giver to the collateral receiver on the date, data identifying exposures associated with the collateral instruments, data identifying on-hold exposures, and/or the like.

In some implementations, the collateral platform may utilize a combination of the machine learning model and the linear programming model to determine a collateral allocation from the collateral giver to the collateral receiver on the date. In some implementations, the collateral platform may first utilize the machine learning model to determine the first collateral allocation, and then may utilize the linear programming model to determine the second collateral allocation if the machine learning model is unable to determine the first collateral allocation (e.g., or if the first collateral allocation is predicted to result in a collateral allocation failure, as described below in connection with FIG. 1F). In such implementations, if the collateral platform is also unable to determine the second collateral allocation with the linear programming model, the collateral platform may determine a collateral allocation from the collateral giver to the collateral receiver on the date based on available collateral (e.g., provided in the eligibility schedule data).

In some implementations, the collateral platform may first utilize the machine learning model to determine the first collateral allocation, and then may utilize the linear programming model to confirm the first collateral allocation. In some implementations, the collateral platform may utilize the machine learning model and the linear programming model to determine collateral allocations and may score and/or weight the collateral allocations in order to determine which collateral allocation to utilize.

As shown in FIG. 1F, and by reference number 135, the collateral platform may determine whether the first collateral allocation is predicted to result in a collateral allocation failure. For example, the collateral platform may determine that a transaction of $10,000, on the date, is to be collateralized with bonds (e.g., the collateral) and that the quantity of bonds utilized will exhaust the inventory of bonds on the date. However, if there is another transaction on the date, with another collateral receiver who is only willing to accept bonds as a covered collateral, the other transaction will fail. This may indicate that the first collateral allocation is predicted to result in the collateral allocation failure.

In some implementations, the collateral platform, when determining whether the first collateral allocation is predicted to result in the collateral allocation failure, may compare the first collateral allocation and the second collateral allocation, and may determine that the first collateral allocation is predicted to result in the collateral allocation failure when the first collateral allocation does not match the second collateral allocation. The collateral platform may determine that the first collateral allocation is predicted to not result in the collateral allocation failure when the first collateral allocation matches the second collateral allocation.

As shown in FIG. 1G, and by reference number 140, the collateral platform may perform one or more actions based on the first collateral allocation or based on the second collateral allocation. In some implementations, the one or more actions may include the collateral platform providing, to the client device, information identifying the first collateral allocation or the second collateral allocation. In this way, the collateral platform enables the user of the client device to view the information identifying the first collateral allocation or the second collateral allocation, to cause the first collateral allocation or the second collateral allocation to be implemented, and/or the like.

In some implementations, the one or more actions may include the collateral platform causing the first collateral allocation or the second collateral allocation to be implemented. In this way, the collateral platform causes a successful collateral allocation to be automatically implemented, which conserves computing resources, networking resources, and/or the like that would otherwise be wasted identifying failed transactions, correcting the failed transactions, and/or the like.

In some implementations, the one or more actions may include the collateral platform retraining the machine learning model based on the first collateral allocation. For example, the collateral platform may retrain the machine learning model based on the first collateral allocation, as described above in connection with FIG. 1C. In this way, the collateral platform improves the predictive capabilities of the machine learning model.

In some implementations, the one or more actions may include the collateral platform providing, to the client device, information indicating that the first collateral allocation is predicted to result in a collateral allocation failure. In this way, the collateral platform ensures that a successful collateral allocation is automatically implemented, which conserves computing resources, networking resources, and/or the like that would otherwise be wasted identifying failed transactions, correcting the failed transactions, and/or the like.

In some implementations, the one or more actions may include the collateral platform updating the blockchain and/or the smart contract based on the first collateral allocation or the second collateral allocation. In this way, the collateral platform ensures that the blockchain and/or the smart contract are automatically updated, which conserves computing resources, networking resources, and/or the like that would otherwise be wasted communicating with the collateral giver and/or the collateral receiver.

In some implementations, the one or more actions may include the collateral platform providing, to client devices associated with collateral giver and the collateral receiver, information identifying the first collateral allocation or the second collateral allocation. In this way, the collateral platform enables the collateral giver and/or the collateral receiver to view the information identifying the first collateral allocation or the second collateral allocation, to cause the first collateral allocation or the second collateral allocation to be implemented, and/or the like.

In some implementations, the one or more actions may include the collateral platform providing post-allocation settlement of collateral associated with the first collateral allocation or the second collateral allocation via the blockchain and/or the smart contract. For example, the blockchain and/or the smart contracts may eliminate a need for generation of settlement instructions for collateral movement since the settlement may occur over the blockchain and/or the smart contract for any changes of exposures, prices of collateral, agreement terms, and/or the like. In this way, the collateral platform ensures that the post-allocation settlement of the collateral is automatically performed, which conserves computing resources, networking resources, and/or the like that would otherwise be wasted performing the post-allocation settlement of the collateral.

As shown in FIG. 1H, and by reference number 145, the collateral platform may provide, to the client device, information identifying the first collateral allocation between the collateral giver and the collateral receiver on the date. In some implementations, the information identifying the first collateral allocation may include information identifying collateral instruments (e.g., ISIN1 and ISIN2) to allocate from the collateral giver to the collateral receiver on the date, information identifying collateral instruments (e.g., ISIN3) not to allocate from the collateral giver to the collateral receiver on the date, information identifying exposures associated with the collateral instruments, and/or the like. As further shown in FIG. 1H, the client device may display the information identifying the first collateral allocation to the user via a user interface.

In this way, several different stages of an automated process for determining collateral allocations are improved via machine learning and blockchain technology, which may improve speed and efficiency of the process and conserve computing resources (e.g., processing resources, memory resources, and/or the like), networking resources, and/or the like. Furthermore, implementations described herein use a rigorous, computerized process to perform tasks that were not previously performed. For example, currently there does not exist a technique that utilizes a machine learning model and blockchain technology to determine collateral allocations. Finally, utilizing a machine learning model and blockchain technology to determine collateral allocations conserves computing resources (e.g., processing resources, memory resources, and/or the like), networking resources, and/or the like that would otherwise be wasted in attempting to determine collateral allocations, and provides increased security to collateral transactions.

As indicated above, FIGS. 1A-1H are provided merely as examples. Other examples may differ from what is described with regard to FIGS. 1A-1H.

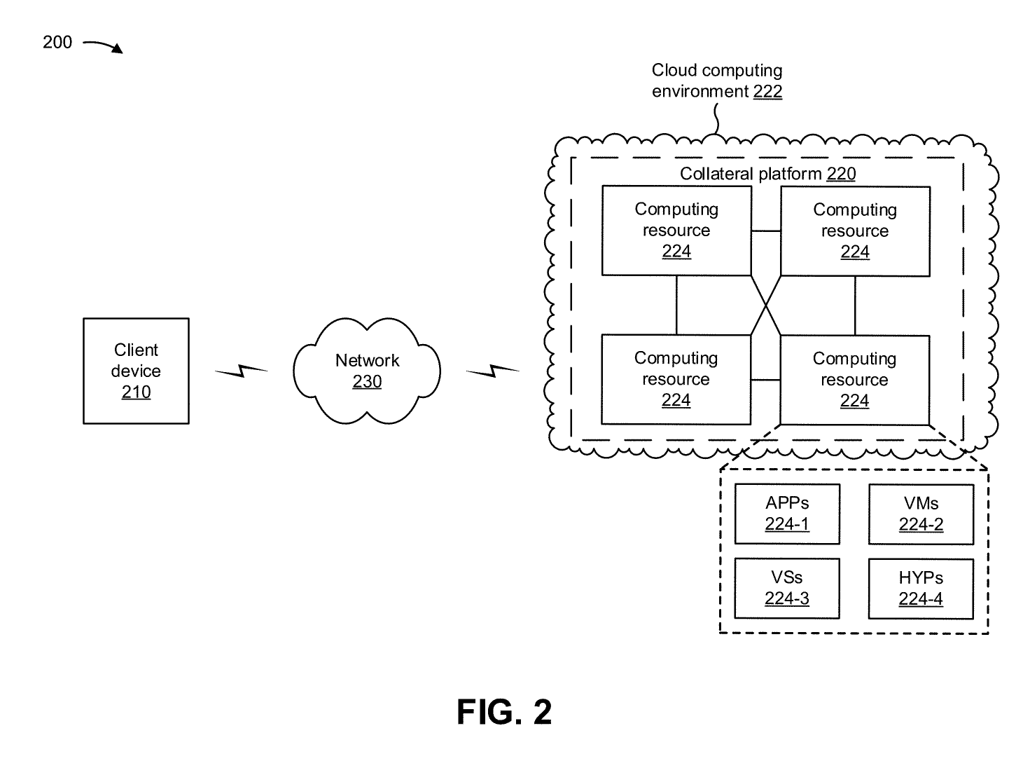

FIG. 2 is a diagram of an example environment 200 in which systems and/or methods described herein may be implemented. As shown in FIG. 2, environment 200 may include a client device 210, a collateral platform 220, and a network 230. Devices of environment 200 may interconnect via wired connections, wireless connections, or a combination of wired and wireless connections.

Client device 210 includes one or more devices capable of receiving, generating, storing, processing, and/or providing information, such as information described herein. For example, client device 210 may include a mobile phone (e.g., a smart phone, a radiotelephone, etc.), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, a head mounted display, etc.), or a similar type of device. In some implementations, client device 210 may receive information from and/or transmit information to collateral platform 220.

Collateral platform 220 includes one or more devices that utilize a machine learning model and blockchain technology to manage collateral. In some implementations, collateral platform 220 may be designed to be modular such that certain software components may be swapped in or out depending on a particular need. As such, collateral platform 220 may be easily and/or quickly reconfigured for different uses. In some implementations, collateral platform 220 may receive information from and/or transmit information to one or more client devices 210.

In some implementations, as shown, collateral platform 220 may be hosted in a cloud computing environment 222. Notably, while implementations described herein describe collateral platform 220 as being hosted in cloud computing environment 222, in some implementations, collateral platform 220 may not be cloud-based (i.e., may be implemented outside of a cloud computing environment) or may be partially cloud-based.

Cloud computing environment 222 includes an environment that hosts collateral platform 220. Cloud computing environment 222 may provide computation, software, data access, storage, etc., services that do not require end-user knowledge of a physical location and configuration of system(s) and/or device(s) that hosts collateral platform 220. As shown, cloud computing environment 222 may include a group of computing resources 224 (referred to collectively as “computing resources 224” and individually as “computing resource 224”).

Computing resource 224 includes one or more personal computers, workstation computers, mainframe devices, or other types of computation and/or communication devices. In some implementations, computing resource 224 may host collateral platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by client device 210. Application 224-1 may eliminate a need to install and execute the software applications on client device 210. For example, application 224-1 may include software associated with collateral platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., a user of client device 210 or an operator of collateral platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

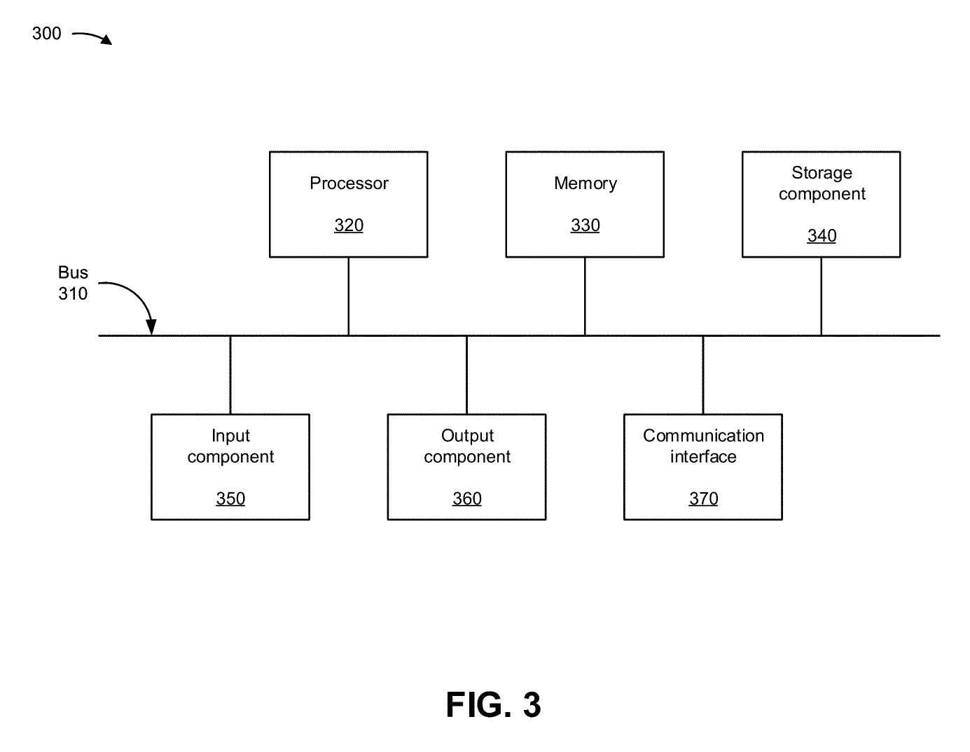

FIG. 3 is a diagram of example components of a device 300. Device 300 may correspond to client device 210, collateral platform 220, and/or computing resource 224. In some implementations, client device 210, collateral platform 220, and/or computing resource 224 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

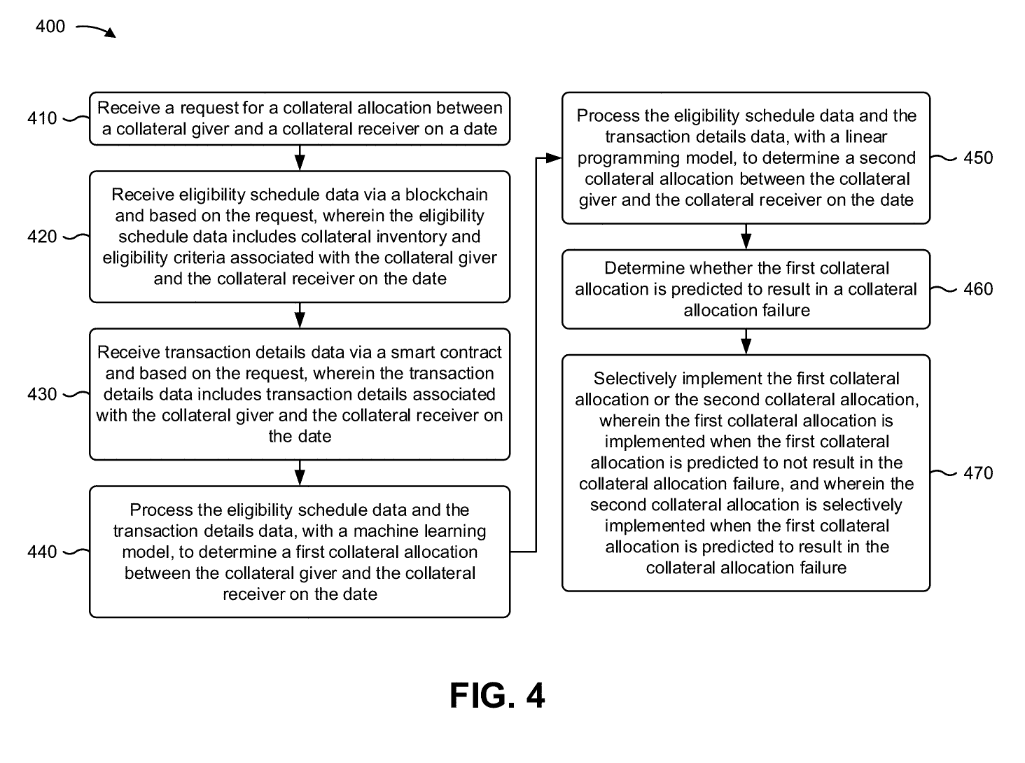

FIG. 4 is a flow chart of an example process 400 for utilizing a machine learning model and blockchain technology to manage collateral. In some implementations, one or more process blocks of FIG. 4 may be performed by a collateral platform (e.g., collateral platform 220). In some implementations, one or more process blocks of FIG. 4 may be performed by another device or a group of devices separate from or including the collateral platform, such as a client device (e.g., client device 210).

As shown in FIG. 4, process 400 may include receiving a request for a collateral allocation between a collateral giver and a collateral receiver on a date (block 410). For example, the collateral platform (e.g., using computing resource 224, processor 320, memory 330, communication interface 370, and/or the like) may receive a request for a collateral allocation between a collateral giver and a collateral receiver on a date, as described above in connection with FIGS. 1A-2.

As further shown in FIG. 4, process 400 may include receiving eligibility schedule data via a blockchain and based on the request, wherein the eligibility schedule data includes collateral inventory and eligibility criteria associated with the collateral giver and the collateral receiver on the date (block 420). For example, the collateral platform (e.g., using computing resource 224, processor 320, storage component 340, communication interface 370, and/or the like) may receive eligibility schedule data via a blockchain and based on the request, as described above in connection with FIGS. 1A-2. In some implementations, the eligibility schedule data includes collateral inventory and eligibility criteria associated with the collateral giver and the collateral receiver on the date.

As further shown in FIG. 4, process 400 may include receiving transaction details data via a smart contract and based on the request, wherein the transaction details data includes transaction details associated with the collateral giver and the collateral receiver on the date (block 430). For example, the collateral platform (e.g., using computing resource 224, processor 320, memory 330, storage component 340, communication interface 370, and/or the like) may receive transaction details data via a smart contract and based on the request, as described above in connection with FIGS. 1A-2. In some implementations, the transaction details data includes transaction details associated with the collateral giver and the collateral receiver on the date.

As further shown in FIG. 4, process 400 may include processing the eligibility schedule data and the transaction details data, with a machine learning model, to determine a first collateral allocation between the collateral giver and the collateral receiver on the date (block 440). For example, the collateral platform (e.g., using computing resource 224, processor 320, storage component 340, and/or the like) may process the eligibility schedule data and the transaction details data, with a machine learning model, to determine a first collateral allocation between the collateral giver and the collateral receiver on the date, as described above in connection with FIGS. 1A-2.

As further shown in FIG. 4, process 400 may include processing the eligibility schedule data and the transaction details data, with a linear programming model, to determine a second collateral allocation between the collateral giver and the collateral receiver on the date (block 450). For example, the collateral platform (e.g., using computing resource 224, processor 320, memory 330, and/or the like) may process the eligibility schedule data and the transaction details data, with a linear programming model, to determine a second collateral allocation between the collateral giver and the collateral receiver on the date, as described above in connection with FIGS. 1A-2.

As further shown in FIG. 4, process 400 may include determining whether the first collateral allocation is predicted to result in a collateral allocation failure (block 460). For example, the collateral platform (e.g., using computing resource 224, processor 320, storage component 340, and/or the like) may determine whether the first collateral allocation is predicted to result in a collateral allocation failure, as described above in connection with FIGS. 1A-2.

As further shown in FIG. 4, process 400 may include selectively implementing the first collateral allocation or the second collateral allocation, wherein the first collateral allocation is implemented when the first collateral allocation is predicted to not result in the collateral allocation failure, and wherein the second collateral allocation is selectively implemented when the first collateral allocation is predicted to result in the collateral allocation failure (block 470). For example, the collateral platform (e.g., using computing resource 224, processor 320, storage component 340, communication interface 370, and/or the like) may selectively implement the first collateral allocation or the second collateral allocation, as described above in connection with FIGS. 1A-2. In some implementations, the first collateral allocation is implemented when the first collateral allocation is predicted to not result in the collateral allocation failure, and the second collateral allocation is selectively implemented when the first collateral allocation is predicted to result in the collateral allocation failure.

Process 400 may include additional implementations, such as any single implementation or any combination of implementations described below and/or described with regard to any other process described herein.

In some implementations, the collateral platform may train the machine learning model with historical exposure allocation data to generate a trained machine learning model that determines a collateral allocation based on inputted eligibility schedule data and inputted transaction details data. In some implementations, the collateral platform may perform one or more actions based on the first collateral allocation or the second collateral allocation.

In some implementations, the collateral platform, when performing the one or more actions, may provide, to a client device associated with the request, information identifying the first collateral allocation or the second collateral allocation; may retrain the machine learning model based on the first collateral allocation; may provide, to the client device and when the first collateral allocation is predicted to result in the collateral allocation failure, information indicating that the first collateral allocation is predicted to result in the collateral allocation failure; may update the blockchain and the smart contract based on the first collateral allocation or the second collateral allocation; and/or may provide, to client devices associated with the collateral giver and the collateral receiver, information identifying the first collateral allocation or the second collateral allocation.

In some implementations, the machine learning model may include a locally estimated scatterplot smoothing (LOESS) model. In some implementations, when the first collateral allocation is predicted to result in the collateral allocation failure and the second collateral allocation is predicted to result in the collateral allocation failure, the collateral platform may determine, based on available collateral inventory, a third collateral allocation between the collateral giver and the collateral receiver on the date; and may implement the third collateral allocation. In some implementations, the collateral platform may provide post-allocation settlement of collateral associated with the first collateral allocation or the second collateral allocation.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

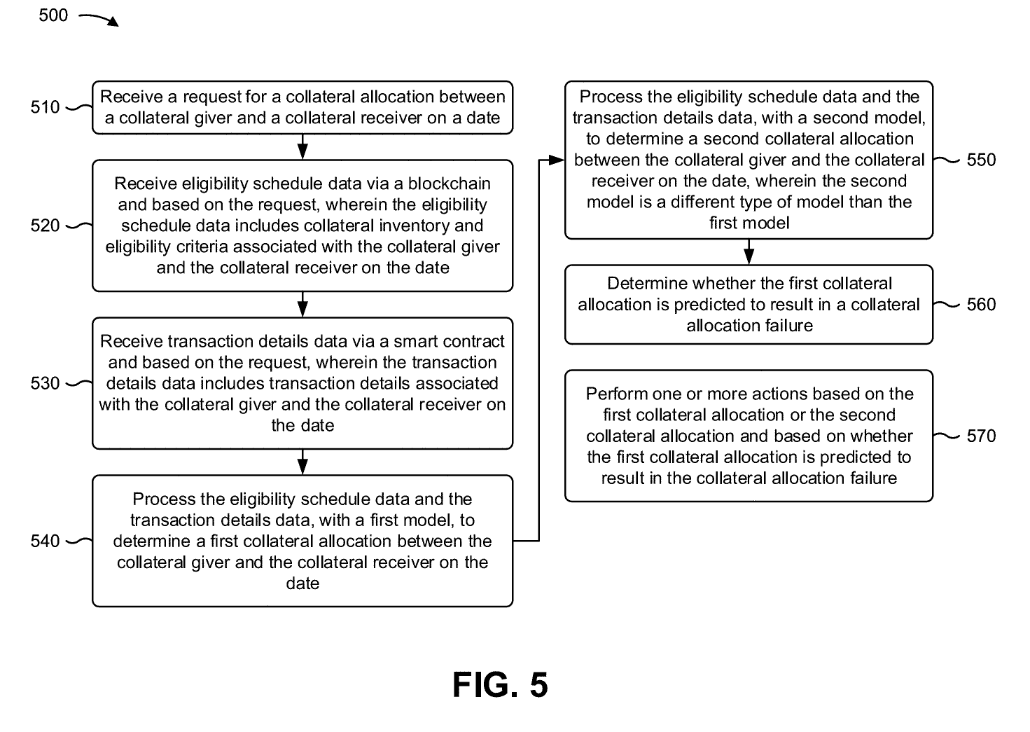

FIG. 5 is a flow chart of an example process 500 for utilizing a machine learning model and blockchain technology to manage collateral. In some implementations, one or more process blocks of FIG. 5 may be performed by a collateral platform (e.g., collateral platform 220). In some implementations, one or more process blocks of FIG. 5 may be performed by another device or a group of devices separate from or including the collateral platform, such as a client device (e.g., client device 210).

As shown in FIG. 5, process 500 may include receiving a request for a collateral allocation between a collateral giver and a collateral receiver on a date (block 510). For example, the collateral platform (e.g., using computing resource 224, processor 320, memory 330, communication interface 370, and/or the like) may receive a request for a collateral allocation between a collateral giver and a collateral receiver on a date, as described above in connection with FIGS. 1A-2.

As further shown in FIG. 5, process 500 may include receiving eligibility schedule data via a blockchain and based on the request, wherein the eligibility schedule data includes collateral inventory and eligibility criteria associated with the collateral giver and the collateral receiver on the date (block 520). For example, the collateral platform (e.g., using computing resource 224, processor 320, storage component 340, communication interface 370, and/or the like) may receive eligibility schedule data via a blockchain and based on the request, as described above in connection with FIGS. 1A-2. In some implementations, the eligibility schedule data includes collateral inventory and eligibility criteria associated with the collateral giver and the collateral receiver on the date.

As further shown in FIG. 5, process 500 may include receiving transaction details data via a smart contract and based on the request, wherein the transaction details data includes transaction details associated with the collateral giver and the collateral receiver on the date (block 530). For example, the collateral platform (e.g., using computing resource 224, processor 320, memory 330, communication interface 370, and/or the like) may receive transaction details data via a smart contract and based on the request, as described above in connection with FIGS. 1A-2. In some implementations, the transaction details data includes transaction details associated with the collateral giver and the collateral receiver on the date.

As further shown in FIG. 5, process 500 may include processing the eligibility schedule data and the transaction details data, with a first model, to determine a first collateral allocation between the collateral giver and the collateral receiver on the date (block 540). For example, the collateral platform (e.g., using computing resource 224, processor 320, memory 330, storage component 340, and/or the like) may process the eligibility schedule data and the transaction details data, with a first model, to determine a first collateral allocation between the collateral giver and the collateral receiver on the date, as described above in connection with FIGS. 1A-2.

As further shown in FIG. 5, process 500 may include processing the eligibility schedule data and the transaction details data, with a second model, to determine a second collateral allocation between the collateral giver and the collateral receiver on the date, wherein the second model is a different type of model than the first model (block 550). For example, the collateral platform (e.g., using computing resource 224, processor 320, memory 330, and/or the like) may process the eligibility schedule data and the transaction details data, with a second model, to determine a second collateral allocation between the collateral giver and the collateral receiver on the date, as described above in connection with FIGS. 1A-2. In some implementations, the second model is a different type of model than the first model.

As further shown in FIG. 5, process 500 may include determining whether the first collateral allocation is predicted to result in a collateral allocation failure (block 560). For example, the collateral platform (e.g., using computing resource 224, processor 320, storage component 340, and/or the like) may determine whether the first collateral allocation is predicted to result in a collateral allocation failure, as described above in connection with FIGS. 1A-2.

As further shown in FIG. 5, process 500 may include performing one or more actions based on the first collateral allocation or the second collateral allocation and based on whether the first collateral allocation is predicted to result in the collateral allocation failure (block 570). For example, the collateral platform (e.g., using computing resource 224, processor 320, memory 330, communication interface 370, and/or the like) may perform one or more actions based on the first collateral allocation or the second collateral allocation and based on whether the first collateral allocation is predicted to result in the collateral allocation failure, as described above in connection with FIGS. 1A-2.

Process 500 may include additional implementations, such as any single implementation or any combination of implementations described below and/or described with regard to any other process described herein.

In some implementations, the collateral platform may selectively implement the first collateral allocation or the second collateral allocation, where the first collateral allocation is to be implemented when the first collateral allocation is predicted to not result in the collateral allocation failure, and where the second collateral allocation is to be implemented when the first collateral allocation is predicted to result in the collateral allocation failure. In some implementations, the collateral platform may train the first model with historical exposure allocation data to generate a trained first model that determines a collateral allocation based on inputted eligibility schedule data and inputted transaction details data.

In some implementations, the collateral platform, when performing the one or more actions, may provide, to a client device associated with the request, information identifying the first collateral allocation or the second collateral allocation; may train the first model based on the first collateral allocation; may provide, to the client device and when the first collateral allocation is predicted to result in the collateral allocation failure, information indicating that the first collateral allocation is predicted to result in the collateral allocation failure; may update the blockchain and/or the smart contract based on the first collateral allocation or the second collateral allocation; and/or may provide, to client devices associated with the collateral giver and the collateral receiver, information identifying the first collateral allocation or the second collateral allocation.

In some implementations, the collateral platform may receive a change associated with the smart contract, may update, based on the change, an exposure start date for the transaction details associated with the collateral receiver, and may update, based on the change, an exposure end date for the transaction details associated with the collateral giver, where the exposure start date and the exposure end date are to be updated prior to processing the eligibility schedule data and the transaction details data with the first model and the second model.

In some implementations, the collateral platform may determine whether the second collateral allocation is predicted to result in the collateral allocation failure; and, when the first collateral allocation is predicted to result in the collateral allocation failure and the second collateral allocation is predicted to result in the collateral allocation failure, the collateral platform may determine, based on available collateral inventory, a third collateral allocation between the collateral giver and the collateral receiver on the date; and may implement the third collateral allocation. In some implementations, the collateral platform may provide post-allocation settlement of collateral associated with the first collateral allocation or the second collateral allocation.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

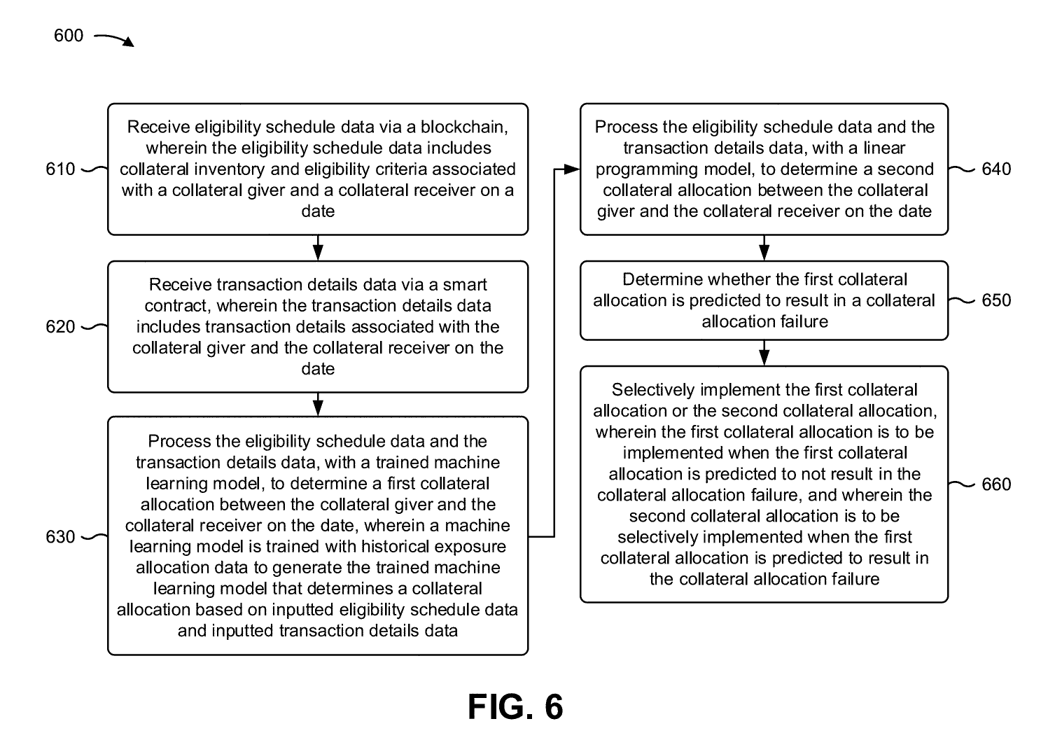

FIG. 6 is a flow chart of an example process 600 for utilizing a machine learning model and blockchain technology to manage collateral. In some implementations, one or more process blocks of FIG. 6 may be performed by a collateral platform (e.g., collateral platform 220). In some implementations, one or more process blocks of FIG. 6 may be performed by another device or a group of devices separate from or including the collateral platform, such as a client device (e.g., client device 210).

As shown in FIG. 6, process 600 may include receiving eligibility schedule data via a blockchain, wherein the eligibility schedule data includes collateral inventory and eligibility criteria associated with a collateral giver and a collateral receiver on a date (block 610). For example, the collateral platform (e.g., using computing resource 224, processor 320, memory 330, communication interface 370, and/or the like) may receive eligibility schedule data via a blockchain, as described above in connection with FIGS. 1A-2. In some implementations, the eligibility schedule data includes collateral inventory and eligibility criteria associated with a collateral giver and a collateral receiver on a date.

As further shown in FIG. 6, process 600 may include receiving transaction details data via a smart contract, wherein the transaction details data includes transaction details associated with the collateral giver and the collateral receiver on the date (block 620). For example, the collateral platform (e.g., using computing resource 224, processor 320, storage component 340, communication interface 370, and/or the like) may receive transaction details data via a smart contract, as described above in connection with FIGS. 1A-2. In some implementations, the transaction details data includes transaction details associated with the collateral giver and the collateral receiver on the date.

As further shown in FIG. 6, process 600 may include processing the eligibility schedule data and the transaction details data, with a trained machine learning model, to determine a first collateral allocation between the collateral giver and the collateral receiver on the date, wherein a machine learning model is trained with historical exposure allocation data to generate the trained machine learning model that determines a collateral allocation based on inputted eligibility schedule data and inputted transaction details data (block 630). For example, the collateral platform (e.g., using computing resource 224, processor 320, memory 330, storage component 340, and/or the like) may process the eligibility schedule data and the transaction details data, with a trained machine learning model, to determine a first collateral allocation between the collateral giver and the collateral receiver on the date, as described above in connection with FIGS. 1A-2. In some implementations, a machine learning model is trained with historical exposure allocation data to generate the trained machine learning model that determines a collateral allocation based on inputted eligibility schedule data and inputted transaction details data.

As further shown in FIG. 6, process 600 may include processing the eligibility schedule data and the transaction details data, with a linear programming model, to determine a second collateral allocation between the collateral giver and the collateral receiver on the date (block 640). For example, the collateral platform (e.g., using computing resource 224, processor 320, memory 330, and/or the like) may process the eligibility schedule data and the transaction details data, with a linear programming model, to determine a second collateral allocation between the collateral giver and the collateral receiver on the date, as described above in connection with FIGS. 1A-2.

As further shown in FIG. 6, process 600 may include determining whether the first collateral allocation is predicted to result in a collateral allocation failure (block 650). For example, the collateral platform (e.g., using computing resource 224, processor 320, storage component 340, and/or the like) may determine whether the first collateral allocation is predicted to result in a collateral allocation failure, as described above in connection with FIGS. 1A-2.

As further shown in FIG. 6, process 600 may include selectively implementing the first collateral allocation or the second collateral allocation, wherein the first collateral allocation is to be implemented when the first collateral allocation is predicted to not result in the collateral allocation failure, and wherein the second collateral allocation is to be selectively implemented when the first collateral allocation is predicted to result in the collateral allocation failure (block 660). For example, the collateral platform (e.g., using computing resource 224, processor 320, memory 330, communication interface 370, and/or the like) may selectively implement the first collateral allocation or the second collateral allocation, as described above in connection with FIGS. 1A-2. In some implementations, the first collateral allocation is to be implemented when the first collateral allocation is predicted to not result in the collateral allocation failure, and the second collateral allocation is to be selectively implemented when the first collateral allocation is predicted to result in the collateral allocation failure.

Process 600 may include additional implementations, such as any single implementation or any combination of implementations described below and/or described with regard to any other process described herein.

In some implementations, the collateral platform may perform one or more actions based on the first collateral allocation or the second collateral allocation. In some implementations, the collateral platform, when performing the one or more actions, may provide, to a client device associated with the request, information identifying the first collateral allocation or the second collateral allocation; may retrain the machine learning model based on the first collateral allocation and when the first collateral allocation is predicted to not result in the collateral allocation failure; may provide, to the client device and when the first collateral allocation is predicted to result in the collateral allocation failure, information indicating that the first collateral allocation is predicted to result in the collateral allocation failure; may update the blockchain and the smart contract based on the first collateral allocation or the second collateral allocation; and/or may provide, to client devices associated with the collateral giver and the collateral receiver, information identifying the first collateral allocation or the second collateral allocation.

In some implementations, the collateral platform may receive a change associated with the smart contract; may update, based on the change, an exposure start date for the transaction details associated with the collateral receiver; and may update, based on the change, an exposure end date for the transaction details associated with the collateral giver, where the exposure start date and the exposure end date are to be updated prior to processing the eligibility schedule data and the transaction details data with the trained machine learning model and the linear programming model.

In some implementations, when the first collateral allocation is predicted to result in the collateral allocation failure and the second collateral allocation is predicted to result in the collateral allocation failure, the collateral platform may determine, based on available collateral inventory, a third collateral allocation between the collateral giver and the collateral receiver on the date, and may implement the third collateral allocation. In some implementations, the collateral platform, when determining whether the first collateral allocation is predicted to result in the collateral allocation failure, may compare the first collateral allocation and the second collateral allocation, may determine that the first collateral allocation is predicted to result in the collateral allocation failure when the first collateral allocation does not match the second collateral allocation, and may determine that the first collateral allocation is predicted to not result in the collateral allocation failure when the first collateral allocation matches the second collateral allocation.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, a request for a collateral allocation between a collateral giver and a collateral receiver on a date;
receiving, by the device, eligibility schedule data via a blockchain and based on the request,
wherein the eligibility schedule data includes collateral inventory and eligibility criteria associated with the collateral giver and the collateral receiver on the date;
receiving, by the device, transaction details data via a smart contract and based on the request,
wherein the transaction details data includes transaction details associated with the collateral giver and the collateral receiver on the date;
processing, by the device, the eligibility schedule data and the transaction details data, with a machine learning model, to determine a first collateral allocation between the collateral giver and the collateral receiver on the date;
processing, by the device, the eligibility schedule data and the transaction details data, with a linear programming model, to determine a second collateral allocation between the collateral giver and the collateral receiver on the date;
determining, by the device, whether the first collateral allocation is predicted to result in a collateral allocation failure; and
selectively implementing, by the device, the first collateral allocation or the second collateral allocation,
wherein the first collateral allocation is implemented when the first collateral allocation is predicted to not result in the collateral allocation failure, and
wherein the second collateral allocation is selectively implemented when the first collateral allocation is predicted to result in the collateral allocation failure.

2. The method of claim 1, further comprising:
training the machine learning model with historical exposure allocation data to generate a trained machine learning model that determines a collateral allocation based on inputted eligibility schedule data and inputted transaction details data.

3. The method of claim 1, further comprising:
performing one or more actions based on the first collateral allocation or the second collateral allocation.

4. The method of claim 3, wherein performing the one or more actions comprises one or more of:
providing, to a client device associated with the request, information identifying the first collateral allocation or the second collateral allocation;
retraining the machine learning model based on the first collateral allocation;
providing, to the client device and when the first collateral allocation is predicted to result in the collateral allocation failure, information indicating that the first collateral allocation is predicted to result in the collateral allocation failure;
updating the blockchain and the smart contract based on the first collateral allocation or the second collateral allocation; or
providing, to client devices associated with the collateral giver and the collateral receiver, information identifying the first collateral allocation or the second collateral allocation.

5. The method of claim 1, wherein the machine learning model includes a locally estimated scatterplot smoothing (LOESS) model.

6. The method of claim 1, wherein when the first collateral allocation is predicted to result in the collateral allocation failure and the second collateral allocation is predicted to result in the collateral allocation failure, the method further comprises:
determining, based on available collateral inventory, a third collateral allocation between the collateral giver and the collateral receiver on the date; and
implementing the third collateral allocation.

7. The method of claim 1, further comprising:
providing post-allocation settlement of collateral associated with the first collateral allocation or the second collateral allocation.

8. A device, comprising:
one or more memories; and
one or more processors, communicatively coupled to the one or more memories, to:
receive a request for a collateral allocation between a collateral giver and a collateral receiver on a date;
receive eligibility schedule data via a blockchain and based on the request,
wherein the eligibility schedule data includes collateral inventory and eligibility criteria associated with the collateral giver and the collateral receiver on the date;
receive transaction details data via a smart contract and based on the request,
wherein the transaction details data includes transaction details associated with the collateral giver and the collateral receiver on the date;
process the eligibility schedule data and the transaction details data, with a first model, to determine a first collateral allocation between the collateral giver and the collateral receiver on the date;
process the eligibility schedule data and the transaction details data, with a second model, to determine a second collateral allocation between the collateral giver and the collateral receiver on the date,
wherein the second model is a different type of model than the first model;
determine whether the first collateral allocation is predicted to result in a collateral allocation failure; and
perform one or more actions based on the first collateral allocation or the second collateral allocation and based on whether the first collateral allocation is predicted to result in the collateral allocation failure.

9. The device of claim 8, wherein the one or more processors are further to:
selectively implement the first collateral allocation or the second collateral allocation,
wherein the first collateral allocation is to be implemented when the first collateral allocation is predicted to not result in the collateral allocation failure, and
wherein the second collateral allocation is to be implemented when the first collateral allocation is predicted to result in the collateral allocation failure.

10. The device of claim 8, wherein the one or more processors are further to:
train the first model with historical exposure allocation data to generate a trained first model that determines a collateral allocation based on inputted eligibility schedule data and inputted transaction details data.

11. The device of claim 8, wherein, when performing the one or more actions, the one or more processors are to one or more of:
provide, to a client device associated with the request, information identifying the first collateral allocation or the second collateral allocation;
train the first model based on the first collateral allocation;
provide, to the client device and when the first collateral allocation is predicted to result in the collateral allocation failure, information indicating that the first collateral allocation is predicted to result in the collateral allocation failure;
update at least one of the blockchain or the smart contract based on the first collateral allocation or the second collateral allocation; or
provide, to client devices associated with the collateral giver and the collateral receiver, information identifying the first collateral allocation or the second collateral allocation.

12. The device of claim 8, wherein the one or more processors are further to:
receive a change associated with the smart contract;
update, based on the change, an exposure start date for the transaction details associated with the collateral receiver; and
update, based on the change, an exposure end date for the transaction details associated with the collateral giver,
wherein the exposure start date and the exposure end date are to be updated prior to processing the eligibility schedule data and the transaction details data with the first model and the second model.

13. The device of claim 8, wherein the one or more processors are further to:
determine whether the second collateral allocation is predicted to result in the collateral allocation failure; and
wherein when the first collateral allocation is predicted to result in the collateral allocation failure and the second collateral allocation is predicted to result in the collateral allocation failure, the one or more processors are further to:
determine, based on available collateral inventory, a third collateral allocation between the collateral giver and the collateral receiver on the date; and
implement the third collateral allocation.

14. The device of claim 8, wherein the one or more processors are further to:
provide post-allocation settlement of collateral associated with the first collateral allocation or the second collateral allocation.

15. A non-transitory computer-readable medium storing instructions, the instructions comprising:
one or more instructions that, when executed by one or more processors of a device, cause the one or more processors to:
receive eligibility schedule data via a blockchain,
wherein the eligibility schedule data includes collateral inventory and eligibility criteria associated with a collateral giver and a collateral receiver on a date;
receive transaction details data via a smart contract,
wherein the transaction details data includes transaction details associated with the collateral giver and the collateral receiver on the date;
process the eligibility schedule data and the transaction details data, with a trained machine learning model, to determine a first collateral allocation between the collateral giver and the collateral receiver on the date,
wherein a machine learning model is trained with historical exposure allocation data to generate the trained machine learning model that determines a collateral allocation based on inputted eligibility schedule data and inputted transaction details data;
process the eligibility schedule data and the transaction details data, with a linear programming model, to determine a second collateral allocation between the collateral giver and the collateral receiver on the date;
determine whether the first collateral allocation is predicted to result in a collateral allocation failure; and
selectively implement the first collateral allocation or the second collateral allocation,
wherein the first collateral allocation is to be implemented when the first collateral allocation is predicted to not result in the collateral allocation failure, and
wherein the second collateral allocation is to be selectively implemented when the first collateral allocation is predicted to result in the collateral allocation failure.

16. The non-transitory computer-readable medium of claim 15, wherein the instructions further comprise:
one or more instructions that, when executed by the one or more processors, cause the one or more processors to:
perform one or more actions based on the first collateral allocation or the second collateral allocation.

17. The non-transitory computer-readable medium of claim 16, wherein the one or more instructions, that cause the one or more processors to perform the one or more actions, cause the one or more processors to one or more of:
provide, to a client device associated with the request, information identifying the first collateral allocation or the second collateral allocation;
retrain the machine learning model based on the first collateral allocation and when the first collateral allocation is predicted to not result in the collateral allocation failure;
provide, to the client device and when the first collateral allocation is predicted to result in the collateral allocation failure, information indicating that the first collateral allocation is predicted to result in the collateral allocation failure;
update the blockchain and the smart contract based on the first collateral allocation or the second collateral allocation; or
provide, to client devices associated with the collateral giver and the collateral receiver, information identifying the first collateral allocation or the second collateral allocation.

18. The non-transitory computer-readable medium of claim 15, wherein the instructions further comprise:
one or more instructions that, when executed by the one or more processors, cause the one or more processors to:
receive a change associated with the smart contract;
update, based on the change, an exposure start date for the transaction details associated with the collateral receiver; and
update, based on the change, an exposure end date for the transaction details associated with the collateral giver,
wherein the exposure start date and the exposure end date are to be updated prior to processing the eligibility schedule data and the transaction details data with the trained machine learning model and the linear programming model.

19. The non-transitory computer-readable medium of claim 15, wherein when the first collateral allocation is predicted to result in the collateral allocation failure and the second collateral allocation is predicted to result in the collateral allocation failure, the instructions further comprise:
one or more instructions that, when executed by the one or more processors, cause the one or more processors to:
determine, based on available collateral inventory, a third collateral allocation between the collateral giver and the collateral receiver on the date; and
implement the third collateral allocation.

20. The non-transitory computer-readable medium of claim 15, wherein the one or more instructions, that cause the one or more processors to determine whether the first collateral allocation is predicted to result in the collateral allocation failure, cause the one or more processors to:
compare the first collateral allocation and the second collateral allocation;
determine that the first collateral allocation is predicted to result in the collateral allocation failure when the first collateral allocation does not match the second collateral allocation; and
determine that the first collateral allocation is predicted to not result in the collateral allocation failure when the first collateral allocation matches the second collateral allocation.
